(19) United States
(12) Patent Application Publication
(10) Pub. No.: US 2014/0363537 A1
(43) Pub. Date: Dec. 11, 2014

(54) PET CHEW WITH AMYLASE AND/OR PROTEASE COMPOSITION

(71) Applicant: Redbarn Pet Products, Inc., Long Beach, CA (US)

(72) Inventor: Steven Benjamin DOERR, Topeka, KS (US)

(73) Assignee: Redbarn Pet Products, Inc., Long Beach, CA (US)

(21) Appl. No.: 14/295,009

(22) Filed: Jun. 3, 2014

Related U.S. Application Data
(60) Provisional application No. 61/832,742, filed on Jun. 7, 2013.

(51) Int. Cl. A23K 1/165; A23K 1/00

(52) U.S. Cl. CPC A23K 1/1653; A23K 1/003
USPC 426/63; 426/64

(57) ABSTRACT

A pet food product and a method for making the same are provided. The pet food product uses a collagen casing with a filling material that contains at least one amylase. The pet food product after drying has desired levels of softness and durability so that it is an effective pet chew product.

### CROSS-REFERENCE TO RELATED PATENT APPLICATIONS

This application claims priority from Provisional Application U.S. Application 61/832,742, filed Jun. 7, 2013, incorporated herein by reference in its entirety.

### BACKGROUND

Pet food products are those food goods intended for consumption by pets, such as dogs, cats, fish, etc. Pet food products exist generally as a food product designed to be the primary dietary intake of an animal. Pet food products can also come in other forms, such as pet chews, which are designed to be consumed slowly over time as the animal masticates the pet chew product. Dogs are one particular type of pet for which pet chew products are designed. Chew products provide dogs with enjoyment while also being beneficial to the dog in the exercise of the jaws and cleaning of the teeth.

### SUMMARY OF THE INVENTION

In one embodiment a pet chew product is provided that has a filling material containing at least one amylase as well as a collagen casing that surrounds the filling material over a length of the filling material.

In another embodiment, a method for manufacturing a pet chew product is provided that involves extruding a collagen casing, filling the collagen casing with a filling material that includes at least one amylase, and drying the filled collagen casing.

### DETAILED DESCRIPTION

Some pet chew products provide a balance of softness and durability by using a bovine esophagus casing. The bovine esophagus is naturally long and muscly, so it can be used as a casing around other material to provide a durable, chewy product. By providing filling material inside the esophagus casing that has a pleasant taste to the pet, such as beef pizzle or animal bone, a durable and chewy pet chew product that provides an enjoyable chewing experience to the pet has been provided. However, certain aspects of the bovine esophagus make it problematic for this purpose as a pet chew casing. Among the issues are the cost of the bovine esophagus, the irregular length of the bovine esophagus, and the difficulty in manufacturing chew products with the bovine esophagus. Other potential casing products include animal intestines, such as pig intestines, and cellulose.

Collagen casing provides a reasonable alternative to esophagus. For example, collagen casings are relatively inexpensive and can be formed in any length. However, collagen casings are not as strong as esophagus casings and as such are not ideal because they would not create a pet chew product with a long chew life. Furthermore, the present inventors discovered that a pet chew product created with a collagen casing was typically too hard and crumbly or brittle once dried. These characteristics of the filling material are similar to those of the filling material found in an esophagus casing pet chew product. However, unlike the esophagus casing pet chew product, the collagen casing around the filling material was generally not durable enough to provide sufficient containment for the crumbly and brittle filling material.

In an attempt to address this problem, the present inventors found that the addition of an amylase resulted in a softer pet chew product after drying. In doing so, the inventors surprisingly discovered that although the amylase softened the original product, the amylase treated product nevertheless maintained the chewiness, and did not substantially compromise durability. This finding was unexpected because the art had heretofore assumed that a relatively softer product would also be a less durable product. Furthermore, given the high protein content in the filling material, an amylase was not expected to have a significant impact on the texture, durability, and consistency of the filling material.

Embodiments of the present invention are directed to pet chew products having a soft, chewable material while also having sufficient durability/strength to have an extended effective duration for chewing. Embodiments of the present invention improve over some existing pet chew products by providing a softer material which allows the pet a more pleasant chewing experience. This is to say that some existing pet chew products are so hard as to provide reduced pleasure in the chewing experience. Embodiments of the present invention improve over some existing pet chew products by providing a more durable material so that the effective life of the chew product is longer. This is to say that some existing pet chew products lack durability or strength so as to result in the chew product deteriorating rapidly as the pet masticates the chew product. By providing softness and durability, embodiments of the present invention provide an improved pet chew product.

Embodiments of the present invention improve over previous pet chew products by using a collagen casing. Collagen casing as used in embodiments of the present invention provide a low cost casing while also having substantially no loss due to irregular length, given that the collagen casing can be extruded in any length. Further, various filling materials can be used to provide a palatable chew product to the pet.

Embodiments of the present invention are created using a drying process. The product created by filling an extruded collagen casing with various palatable materials will generally have a level of moisture that is higher than desired for the pet chew product. Therefore, after extrusion/filling, the pet chew product is dried to remove excess moisture. In some embodiments, the drying is performed until the moisture content is less than 15% in the pet chew product. In other embodiments, the drying is performed until the moisture content is less than 5% in the pet chew product. In other embodiments, the drying is performed until the moisture content is less than 3% in the pet chew product. In other embodiments, the drying is performed until the moisture content is less than 1% in the pet chew product.

The use of a collagen casing for a pet chew product is counterintuitive. Persons of ordinary skill in the art would generally expect a collagen casing to be unsuitable for the pet chew product because it does not have the durability desired for such a casing. The esophagus casing was a logical choice for a casing because it is highly durable due to its muscly consistency. Extruded collagen casing, however, would not be expected to provide nearly the same level of durability if exchanged for the esophagus casing. Furthermore, drying of the collagen casing chew product would be expected to produce a fragile, crumbly product. Indeed a collagen casing product would lack the desired durability and prove to be fragile when dried if a simple substitution for the esophagus casing were performed. Nonetheless, embodiments of the present invention solve these problems as described below.

Embodiments of the present invention provide a balance of softness and durability with a collagen casing “chew” product through the use of an amylase and/or protease in the filling material. The filling material for the collagen casing chew product can be any mixture of materials. Generally, materials that are palatable to the pets are chosen in order to increase the interest of the pet in the chew product. For this reason, beef pizzle is a common component of the filling material. Other materials such as maltodextrin or other starches can be used in the filling material to provide a low cost component of the filling material. The components of the filling material will have an effect on the overall softness and durability of the pet chew product upon drying. While the collagen casing in conjunction with a filling material composed of any variety of common filling products generally produces a hard, brittle product with very little durability upon drying, embodiments of the present invention contain amylase as a product in the filling material and these embodiments are soft and durable upon drying.

The amylase can be added as a component of the filling material in various amounts while still producing the desired softness and durability effects. The present invention is not restricted to any particular amylase or class of amylases. Indeed, the present invention contemplates that use of α, β, and γ amylases. Alpha-amylases α-amylases include 1,4-α-D-glucan glucanohydrolase; glycogenase, and are calcium matalloenzymes. Beta-amylases include 1,4-α-D-glucan maltohydrolase; glycogenase; and saccharogen amylase. Gamma-amylases include Glucan 1,4-α-glucosidase; amyloglucosidase; exo-1,4-α-glucosidase; glucoamylase; lysosomal α-glucosidase; and 1,4-α-D-glucan glucohydrolase.

Further the present invention is not restricted to amylases from any one particular source. Rather, the present invention contemplates the use of any mammalian amylase, including bovine amylases. The products of the invention may be provided with a single amylase or one or more amylases. Preferably, where multiple amylases are used, an amylase from separate classes are used (e.g., α amylase with a β amylase). Commercially available sources of amylases include Novozymes BAN 480 L, Enzyme Development Corporation ENZECO Fungal Amylase, Sweetase, RONOZYMES RumiStar, Termamyl.

The ideal amount of amylase included in the filling material is dependent to some degree on the other components making up the filling material. In some embodiments, the filling material contains between 0.01 wt % and 0.50 wt % amylase as a portion of the total filling material content. In other embodiments, the filling material contains between 0.10% and 0.45% amylase. In other embodiments, the filling material contains between 0.20% and 0.40% amylase. In other embodiments, the filling material contains between 0.25% and 0.35% amylase.

Embodiments of the present invention improve over collagen casing chew products that lack an amylase component in the filling material by being softer after drying. Collagen casing chew products created without amylase in the filling material were found to have durometer values of 90 and greater on the Type A scale. This generally reflected a chew product that would be too hard to be of enjoyment to a pet. Embodiments of the present invention with a collagen casing and an amylase component in the filling material have lower durometer values, which means that they are softer. The softness is dependent to some degree on the amount of amylase included in the filing material as well as the other components of the filling material.

In some embodiments, the chew product has a durometer value between 80 and 88. In other embodiments, the chew product has a durometer value between 60 and 80. In other embodiments, the chew product has a durometer value between 50 and 70. In other embodiments, the chew product has a durometer value between 40 and 60. As compared to a similar collagen casing pet chew product lacking the amylase component, the pet chew products with the amylase component had in some embodiments a reduction in hardness of up to 60%. In some embodiments, the amylase-containing pet chew products had a reduction in hardness of up to 40%. In some embodiments, the amylase-containing pet chew products had a reduction in hardness of up to 20%. In some embodiments, the amylase-containing pet chew products had a reduction in hardness of up to 10%.

Embodiments of the present invention improve over experimental collagen casing chew products that lack an amylase component in the filling material by unexpectedly being nearly as durable as the esophagus casing chew products. The present inventors surprisingly discovered that although softer, the collagen casing chew products comprising amylase maintained a level of durability akin to equivalent products lacking amylase. after drying would be highly durable due to the use of an amylase in the filling material. The amylase might be expected to hydrolyze the starches in the filling material, but no particular effect on the protein-based collagen casing would be expected by someone of ordinary skill in the art. However, embodiments of the present invention having an amylase in the filling material typically have a reduced effective durability or chew time of no greater than 20% as compared to the esophagus casing chew products. Some embodiments have a reduced effective durability or chew time of no greater than 10% as compared to the esophagus casing chew products.

In some embodiments of the present invention, a protease may also be included in the filling material in order to increase the softness of the chew product. The present invention is not restricted to any particular protease or class of proteases. Indeed, the present invention contemplates that use of serine, threonine, cysteine, aspartate, glutamic, and metallo proteases. Serine proteases include trypsin-like proteases, chymotrypsin-like proteases, and elastase-like proteases. Threonine proteases include class T01 proteases of proteasome components, class T02 proteases of glycosylasparaginases, and class T03 proteases of γ-glutamyltransferases. Cysteine proteases include a wide variety of proteases commonly occurring in plants, such as actinidain, bromelain, and calpains. Aspartate proteases include pepsins, cathepsins, and renins Metalloproteinases include metalloexopeptidases and metalloendopeptidases. When using a protease, preferably less than 0.015 wt % of the filling material is used.

The filling material can contain a variety of components. In general, the filling material should have a pleasant taste to the pet so that the pet is motivated to chew on the pet chew product. For this reason, a key component of the filling material is often beef pizzle or an animal bone. Some embodiments of the present invention use beef pizzle mixed with other ingredients. For instance, while beef pizzle may comprise the key filling element for providing a palatable pet chew product, a sweetener such as maltodextrin or corn syrup may also be included in the filler material. Further, low cost filler products such as potato starch may be included. The flavor of the filler material may be augmented through the use of ingredients such as chicken meal, liquid smoke, and salt. In addition to or as an alternative to beef pizzle, other protein ingredients can be used such as muscular tissue. A common mixture of these ingredients for some embodiments consists, before drying, of about 45% protein ingredients, about 27% carbohydrate ingredients, about 20% to 25% moisture, and about 2% fat ingredients. Preferably, the protein content is greater than 40%, 50% or even 60%, by weight of the total filling material.

In some embodiments, alternative casing material can be used, such as animal intestines or cellulose. In these embodiments, the general composition of the filling material can be similar to that used with a collagen casing, however additional steps may be required in the process of making such products, such as removing a non-edible cellulose casing after drying of the pet chew product and before packaging for sale.

### EXAMPLES

One example embodiment of a pet chew product is given in this paragraph. Using a collagen casing, the pet chew product has a filling material comprising: 40% beef pizzle product, 30% maltodextrin, 10% potato starch, 10% chicken meal, 1% liquid smoke, 4% glycerin, 2.5% salt, 0.3% Novozyme Ban L amylase, and 2.2% other products.

A second example embodiment of a pet chew product is given in this paragraph. Using a collagen casing the pet chew product has a filling material comprising of: 48% beef pizzle product, 34% corn syrup, 10% potato starch, 4% glycerin, 2.5% salt, 0.15% Novozyme Ban L amylase, 0.01% papain protease, and 1.34% other products.

While durability and chew time of a pet chew product is somewhat variable depending on the particular animal consuming the pet chew product, some embodiments of the present invention tended to have chew time of 20 minutes or more. When the same pets were given an esophagus casing pet chew product, those pet chew products tended to have chew time of around 25 minutes. Therefore, where chew time was reduced as compared to the esophagus casing pet chew product, the chew time was only reduced, if at all, by a nominal amount.

While embodiments of the pet chew product herein described can be created in a variety of ways, one example embodiment of a method for creating a pet chew product is described. First, the filling material is prepared by mixing all components together except for the amylase, protease, and water. This step consists of dry blending all of the ingredients together. Once this mixture has been prepared, the amylase and/or protease is added. Water is then added to bring up the moisture content of the mixture to around 20% to 25%. The mixture is then further blended to allow even distribution of the water, amylase, and protease throughout the mixture. This mixture is preferably made in such conditions and with such timing so that the amylase and/or protease is active in the mixture immediately prior to and during extrusion into the collagen casing.

The filling material is then filled into the collagen casing using a conventional extruder device. Any extrusion technique known in the art may be used for this process. Once the filling material is extruded into the collagen casing, the length of the encased material can be cut into desired lengths, such as in seven inch segments. These segments are then placed into a convection oven for drying. The segments are placed in the oven without preheating the oven. The oven is then set to reach 200 degrees Fahrenheit. Once the internal temperature of the segments reaches about 170 degrees Fahrenheit, the amylase and protease will no longer be active.

All of these steps are performed so that the amylase and/or protease are active in the mixture for about 25 to 60 minutes, preferably 30 to 50 minutes, more preferably, about 30 to 45 minutes. The desired effects of the amylase and/or protease components can be achieved with different time frames as well. For instance, if more amylase is used as a percentage of the filling material content, then less reaction time should be allowed, whereas use of less amylase as a percentage of the filling material would require more reaction time for the amylase in the filling material. The segments are left in the oven to dry overnight, i.e., for about six to eight hours. Once dried, the pet chew product is complete and can be packaged for sale.

What is claimed is:

1. A pet chew product comprising:
a filling material comprising at least one amylase; and
a casing surrounding said filling material over a length of said filling material, wherein the casing comprises collagen, intestine or cellulose.

2. The pet chew product of claim 1, wherein the casing comprises cellulose.

3. The pet chew product of claim 1, wherein the at least one amylase comprises between 0.01% and 0.025% of the filling material.

4. The pet chew product of claim 1, wherein the at least one amylase comprises between 0.025% and 0.1% of the filling material.

5. The pet chew product of claim 1, wherein the at least one amylase comprises between 0.075% and 0.3% of the filling material.

6. The pet chew product of claim 1, wherein the at least one amylase comprises between 0.15% and 0.45% of the filling material.

7. The pet chew product of claim 1, wherein the pet chew product has a hardness of between 80 and 88 when measured on a durometer scale.

8. The pet chew product of claim 1, wherein the pet chew product has a hardness of between 60 and 80 when measured on a durometer scale.

9. The pet chew product of claim 1, wherein the pet chew product has a hardness of between 50 and 70 when measured on a durometer scale.

10. The pet chew product of claim 1, wherein the pet chew product has a hardness of between 40 and 60 when measured on a durometer scale.

11. The pet chew product of claim 1, wherein the filling material further comprises at least one protease.

12. The pet chew product of claim 11, wherein the protease comprises less than 0.015% of the filling material.

13. The pet chew product of claim 1, wherein the filling material further comprises beef pizzle.

14. The pet chew product of claim 1, wherein the at least one amylase is an alpha-amylase.

15. The pet chew product of claim 1, wherein the casing does not comprise esophagus.

16. A method for manufacturing a pet chew product comprising:
extruding a collagen casing;
filling said collagen casing with a filling material, wherein said filling material comprises at least one amylase; and
drying said collagen casing and filling material.

17. A method for manufacturing a pet chew product comprising:
preparing a filling material by mixing an amylase and/or protease with filling ingredients;
filling a collagen casing with the filling material; and
drying said collagen casing and filling material.
